(19) United States
(12) Patent Application Publication
(10) Pub. No.: US 2012/0181801 A1
(43) Pub. Date: Jul. 19, 2012

(54) Reinforcement device for door sockets

(76) Inventors: Magnolia K. Willis, Durham, NC (US); Robert L. Key, Jonesboro, GA (US)

(21) Appl. No.: 12/981,738

(22) Filed: Dec. 30, 2010

(51) Int. Cl. E05C 17/44

(52) U.S. Cl. 292/338

(57) ABSTRACT

A door socket cover serves to substantially improve the reliability of the door socket assembly. A door socket cover is mounted on top of a door socket on the door frame. The cover is a single sheet of metal which wraps around the door frame to reinforce and stabilize the socket assembly.

We claim the priority of provisional patent application # 61/335,170 filed on Dec. 31, 2009.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

There is an ever increasing need and demand for improving the security and structural integrity of entry doors. This demand is being driven by the repeated occurrences of unauthorized and forced entry through entry doors.

Typically such improvements have focused on pick resistant locks, longer and stronger dead bolts and guard plates. Most exterior doors are made of metal and these locks and bolts are mounted and anchored into very soft wooden door sockets, making their overall effectiveness minimal for security purposes when utilized without overall reinforcement. The bolt screws generally extend into the door socket through a strike plate that is held in place by short screws. These screws only extend a short distance into the door socket to secure the strike plate around a receiving opening that is located very close to the inner edge of the socket. The resulting orientation of the lock bolt, strike and receiving opening is that a thin section of the wooden door socket is all that remains to resist inward motion of the door slab when the lock bolt is engaged. With this arrangement a person may cause the bolt to rip through the retaining section of the door assembly or socket by applying sufficient force to the door slab itself. Consequently, forced entry may be gained without any disturbance or defeat of the locking device.

Devices currently on the market that are designed for strengthening and reinforcing this vulnerable area have considerable shortcomings. The design of existing products does not permit reinforcement of door sockets while the door and socket remain in place—the door frame components must be removed and reinstalled or replaced. Such devices require that the purchaser have a high level of carpentry skill to disassemble the door, install the device and reinstall the door. Taking on such a project or expense certainly proves daunting to many consumers with a need for such a product. Furthermore, many of these devices are very conspicuous, making the exteriors of the homes and businesses they protect more unattractive and giving burglars ample time to evaluate and plan to evade their protection.

### BRIEF SUMMARY OF THE INVENTION

We have created a door socket cover that substantially improves the reliability of the door socket assembly. The beauty of our invention is its simplicity. Our invention is a single thin metal cover (molded to fit standard door sizes) that is mounted on top of a door socket on the door frame to reinforce and stabilize the socket assembly. This invention addresses the public need for a product that addresses the structural vulnerability to forced entry of vertically hung door assemblies in new and existing structures. Persons living in high-crime areas or seeking additional feelings of security need a door cover device that 1) a layperson can install with ease and 2) addresses the overall structural inadequacy of doors mounted in and supported by wooden door sockets. Our device does both.

### BRIEF DESCRIPTION OF THE SEVERAL VIEWS OF THE DRAWING¹

FIG. 1a is a front elevation view of an entry door assembly incorporating cover components described herein.

FIG. 1b is a top, cross-sectional view of the door cover in FIG. 1a.

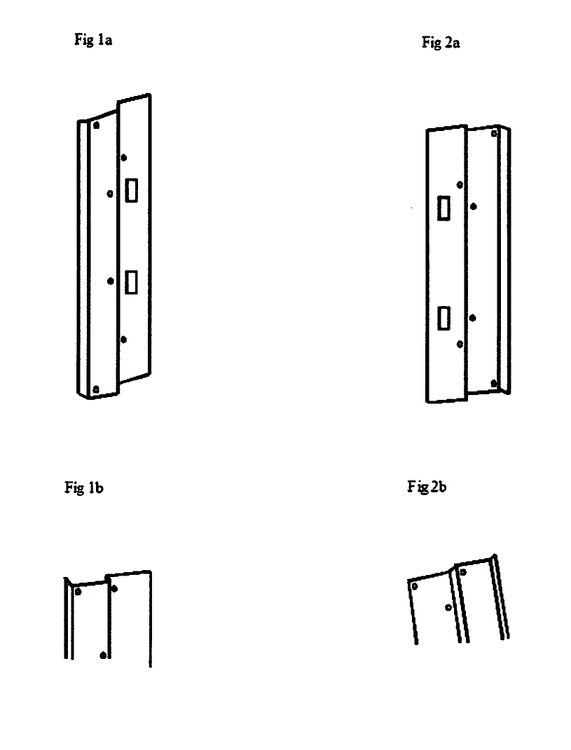

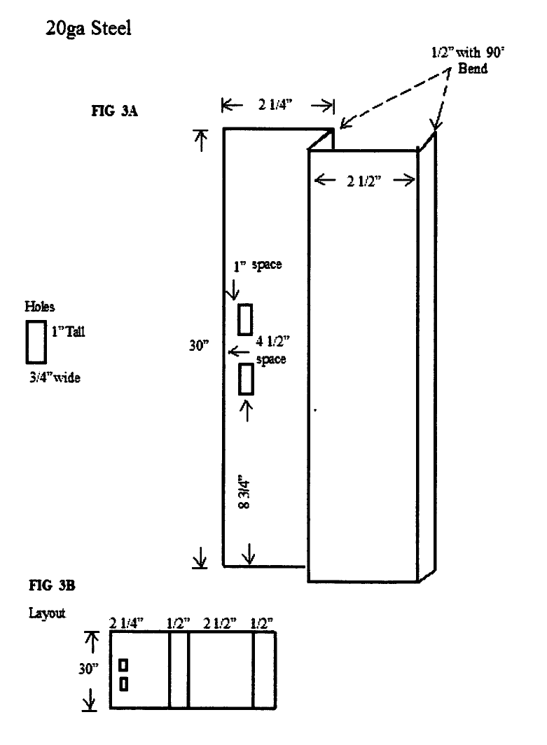

FIG. 2 is a back elevation view of an entry door assembly incorporating cover components described herein. FIG. 2b is a top, cross-sectional view of the door cover in FIG. 2a.

FIG. 3 is a front elevation view with dimensions of an entry door assembly incorporating cover components described herein. FIG. 1a is a front elevation view of the reinforcement device. It is 30 inches long and 5 ½ inches wide. It has a ½ inch bend on the left outer edge, followed by a 2 ½ inch flat surface with four screw holes. The screw holes are staggered to provide extra strength. Next is a ½ inch 90 degree fold. Then there is a 2 ¼ flat surface with three screw holes and two lock bolt plunger openings. The screw holes are counter sunk. This allows the screws to fit flush with the steel surface. The screw holes will accommodate #10 three inch counter sunk screws. The first lock bolt plunger opening is 11 ¾ inches from the top and ¾ inch from the 90 degree fold. It is ¾ inch wide and 1 ¼ inches long. The second lock bolt plunger opening is 17 ¼ inches from the top and ¾ inch from the 90 degree fold. It is ¾ inch wide and 1 ¼ inches long. The bolt lock plunger openings are 5 ½ inches center to center.FIG. 2a is a reversed elevation view of FIG. 1a. It is 30 inches long and 5 ½ wide. It has a 2 ¼ flat surface with three screw holes and two lock bolt plunger openings. The screw holes are counter sunk. This allows the screws to fit flush with the steel surface. The screw holes will accommodate #10 three inch counter sunk screws. The first lock bolt plunger opening is 11 ¾ inches from the top and ¾ inch from the 90 degree fold. It is ¾ inch wide and 1 ¼ inches long. The second lock bolt plunger opening is 17 ¼ inches from the top and ¾ inch from the 90 degree fold. It is ¾ inch wide and 1 ¼ inches long. The lock bolt plunger openings are 5 ½ inches center to center. Next is the ½ inch 90 degree fold. Then there is a 2 ½ inch flat surface with four screw holes.

### DETAILED DESCRIPTION OF THE INVENTION

The present invention described and further detailed herein is particularly useful as a security device for the reinforcement of door assemblies while the assembly remains mounted in an existing structure, i.e. the fixed to the structure at the location desired by the end-user. Accordingly, a door assembly, as shown in FIGS. 1a, 1b, 2a and 2b, shall be an assembly including a door slab that is hinged along one vertically elongated edge, then fixed to the door socket along a vertical member allowing the door slab to swing and thus accommodate opening and closing. Lock hardware shall typically involve a dead bolt that has the locking mechanism mounted on the interior and exterior faxe of the door, and is manually manipulated by a key to lawfully unlock the door from the exterior side. A knob or key may be used to control the operation of the dead bolt lock from the interior side to engage and disengage the lock bolt plunger from the receiving opening of the door socket. Typically exterior doors are made of metal.

A door socket, also commonly known as the finished frame, shall ordinarily be comprised of opposing vertical socket members that will be joined together by upper and lower common horizontal socket members. The door assembly detail in FIGS. 1a, 1b, 2a and 2b illustrates the door socket is securely affixed to the rough frame, positioned true with shims to ensure proper alignment and secured with suitable attaching hardware. Decorative molding shall conceal the area immediately around the door socket on the inner and outer walls, and extends along the floor of the structure.

Accordingly, the plunger portion of both lock bolts pass through a strike plate of conventional construction and similarly mounted. Then it engages the opposing vertical door socket member adjacent to the door slab free swinging edge and engages the bolt receiving openings very near its interior edge. Typically, the bolt plunger of the dead bolt will penetrate more deeply into the door socket than the bolt plunger of the latch bolt and consequently requires the receiving opening to be suitably sized.

The featured embodiment of FIGS. 1a, 1b, 2a and 2b relate to a hinged side socket cover that is an elongated steel sheet shaped to form a slide on a sheet. The cover is then contoured to advance perpendicular and immediately abutted to the complete interior edge of the door socket, before again bending perpendicular to be positioned along the entire posterior width of the vertical door socket member of the fixed side of the door assembly. The component will have multiple countersunk openings along the first panel into which the mounting hardware is secured. The component will be arranged such that the open section of the elongated metal sheet created by the aforementioned coinciding perpendicular bends of the sheet will be facing the interior edge of the vertical door socket member previously detailed. The cover will be constructed with an opening along the facing surface large enough to accommodate the hinge portion previously mounted, in typical fashion, to the vertical socket member. The cover will extend onto the offset plane of the vertical door socket member facing surface with its opening centering on the hinge fixture. While positioned thusly the extreme edges of the equivalent upper and lower sections will come to rest flush against the offset surface and behind the weather sealing component while maintaining a close parallel orientation to the offset plane. The cover will extend along closely and parallel to the entire width of the posterior region of the same vertical door socket.

In use, the present cover of invention can be characterized by its multi-functionality, ease of installation, adaptability, superior design and simplicity. Briefly, the steps for installation follow:

1. Position the socket cover component.

2. Form holes in the corresponding door socket for reception of screws.

3. Secure the socket cover in place with suitable screws.

4. Position the hinge side socket cover component, ensuring it lines up with the lock bolt plungers openings.

5. Remove the locking devices from the door slab surfaces.

6. Position the door cover component on the door slab free swinging edge so as to allow the lock bolt plungers to pass through the corresponding openings in it.

7. Secure the component in place with suitable screws.

All of these steps can be completed by a layperson with no more tools on hand than a single screwdriver.

When deployed, the security cover retrofits to and reinforces the security offered by existing door assemblies. This is achieved by the cover wrapping key locking elements of a door frame assembly in metal and securing them to the surrounding structure. The wrapping design reinforces these elements by placing metal along the typical load bearing surfaces exposed to forced entry attempt. thereby preventing the splintering of the door assembly.

Having thus described and detailed the present invention, we would like to note that many obvious and apparent variations in construction may be made without departing from the overall scope and spirit thereof as defined by the appended claims (such as anticipated changes in color). Furthermore, it is intended that the foregoing specifications and accompanying drawings be interpreted as illustrative rather than in a limiting sense.

1. We claim right, title and ownership of the design of a door socket cover mounted around a wooden door socket, the cover comprising a single piece of metal having a wrapping shape as illustrated in FIG. 1b,
a) whereby the sheet is positioned around the receiving portions of the door socket, fastening the door socket cover to the door socket and to the door frame using fasteners (screws);
b) wherein the side panel of the metal sheet comprises an opening adapted to receive a door dead bolt and/or door bolt plunger; and
c) wherein the metal sheets are comprised of steel having a thickness in the range of 18 to 20 gauge.
